(19) United States
(12) Patent Application Publication
(10) Pub. No.: US 2012/0025437 A1
(43) Pub. Date: Feb. 2, 2012

(54) LIGHTWEIGHT CARBON FIBER C-CLAMP

(75) Inventors: Jimmie B. Allred, III, Skaneateles, NY (US); Edmund Zielinski, Liverpool, NY (US); Michael D. Griswold, Syracuse, NY (US); Michael J. Hall, Camillus, NY (US); Matthew A. Bush, LaFayette, NY (US); Joseph Kummer, Fayetteville, NY (US)

(73) Assignee: ALLRED & ASSOCIATES INC., Elbridge, NY (US)

(21) Appl. No.: 13/191,715

(22) Filed: Jul. 27, 2011

Related U.S. Application Data
(60) Provisional application No. 61/368,713, filed on Jul. 29, 2010.

(51) Int. Cl. B25B 5/16; B29C 33/38; B29C 70/68; B25B 5/10; B29C 67/00

(52) U.S. Cl. 269/249; 269/286; 264/334; 264/271.1; 264/219

(57) ABSTRACT

The carbon fiber c-shaped clamp tool is preferably used in wood working and instrument manufacturing. The carbon fiber c-clamp tool preferably includes a main body, carbon fiber sleeves, pads, one or more threaded rods, and turning knobs. In a preferred embodiment, the main body and sleeves are made of unidirectional carbon fiber. A method connects the main body and sleeves by extending the carbon fibers from the main body to the sleeves and wrapping them around threaded inserts.

### REFERENCE TO RELATED APPLICATIONS

This application claims one or more inventions which were disclosed in Provisional Application No. 61/368,713, filed Jul. 29, 2010, entitled “LIGHTWEIGHT CARBON FIBER C-CLAMP”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of clamps. More particularly, the invention pertains to c-clamps used in securing objects.

2. Description of Related Art

The c-clamp is a standard tool used in the wood-working trade, and in particular in the manufacture of musical instruments. C-clamps are shaped in the form of a “C” formed by two arms and a base connecting the two arms. Typically, a threaded rod passes through a matching threaded hole in the first arm and extends toward the second arm such that an object can be secured between the second arm and the threaded rod.

Current c-clamps are made from wood, plastic, or metal (for example steel or aluminum), and come in a wide variety of sizes. Many patents have been issued related to c-clamp tools; however, the focus of these is heavily weighted toward improving the clamping mechanism itself, and in particular, the ability to quickly adjust the size of the clamp opening. Relatively little effort has been placed on the optimization of the stiffness to weight ratio for the clamp.

U.S. Pat. No. 236,239 (Morris) discloses a c-clamp with a nut used for rapid width adjustment.

U.S. Pat. No. 2,659,561 (Kindorf) discloses a c-clamp in which the main body is fabricated from a piece of bent steel plate and uses standard nuts and bolts instead of a clamping screw.

U.S. Pat. No. 3,704,014 (Keene), U.S. Pat. No. 4,582,307 (Wang), U.S. Pat. No. 5,732,936 (Lii), and U.S. Pat. No. 6,708,966 (Troudt) are examples of rapid adjustment methods for c-clamps.

### SUMMARY OF THE INVENTION

An improved c-shaped clamp tool is preferably used in wood-working and instrument manufacturing. The carbon fiber c-clamp tool preferably includes a main body, carbon fiber sleeves, pads, one or more threaded rods, and turning knobs. In a preferred embodiment, the main body and sleeves are made of unidirectional carbon fiber. A method connects the main body and sleeves by extending the carbon fibers from the main body to the sleeves and wrapping them around threaded inserts.

### BRIEF DESCRIPTION OF THE DRAWINGS

FIG. 1a shows a side view of a carbon fiber c-clamp in an embodiment of the present invention.

FIG. 1b shows a bottom view of the carbon fiber c-clamp of FIG. 1a.

FIG. 2a shows a side view of another embodiment of a carbon fiber c-clamp with a large thickness change along the main body of the clamp.

FIG. 2b shows a bottom view of the carbon fiber c-clamp of FIG. 2a.

FIG. 3a shows a side view of another embodiment of a carbon fiber c-clamp with a constant cross-section along the main body of the clamp.

FIG. 3b shows a bottom view of the carbon fiber c-clamp of FIG. 3a.

FIG. 4 shows an angled view of the carbon fiber c-clamp of FIG. 1a.

FIG. 5 shows another embodiment of the carbon fiber c-clamp with two threaded rods.

FIG. 6 shows an angled view of the carbon fiber c-clamp of FIG. 1a with the threaded rod and pads hidden.

### DETAILED DESCRIPTION OF THE INVENTION

C-shaped clamps have been used for many years. Some uses for c-clamps include, but are not limited to, wood-working, and in particular in the construction of musical instruments. In the construction of musical instruments, as well as other delicate wood assemblies, a need exists for lighter weight, yet highly stiff c-clamps. As an improvement to standard thermoplastics, the addition of glass fibers into the resin has been used to improve material properties in the construction of lightweight c-clamps.

Although the incorporation of short glass fibers into the design offers modest gains in clamp stiffness, significantly greater stiffness to weight ratio can be achieved through the use of long, unbroken carbon fibers.

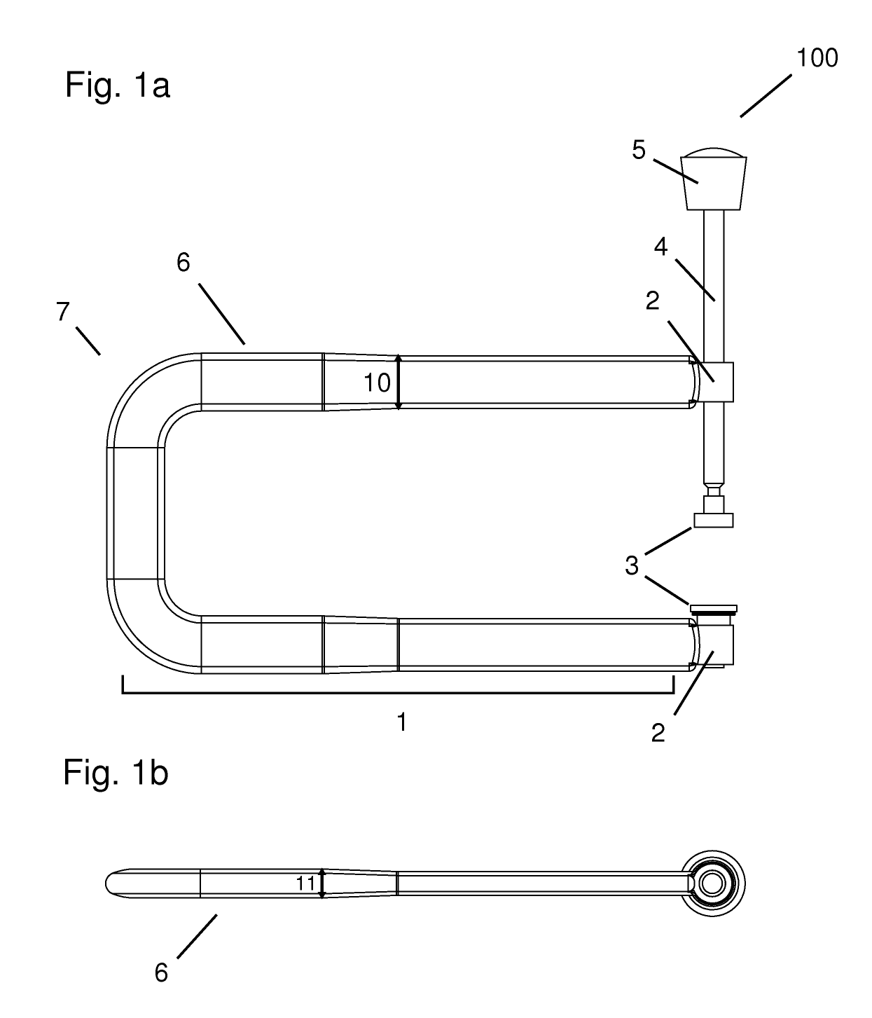

FIG. 1a shows an assembled carbon fiber c-clamp 100 in an embodiment of the present invention. The carbon fiber c-clamp 100 includes a main body 1, carbon fiber sleeves 2, pads 3, a threaded rod 4, and a knob 5. Although a knob 5 is shown in the figure, alternative turning mechanisms, such as screws, could be used instead of the knob 5. In other embodiments, the clamps described herein would also work without a turning mechanism. In embodiments without a turning mechanism, the threaded rod 4 itself would be turned to tighten or loosen the clamp.

In use, the knob 5 is turned to adjust the distance between the pads 3. When the clamp is tightened, the knob 5 is turned until the object is secured in place. To loosen the clamp, the knob 5 is turned in the opposite direction until the secured object can be moved or removed.

The main support member 1 is preferably made of unidirectional carbon fibers. The fibers are preferably oriented such that they lay along the long axes of the clamp arms. By orienting the fibers in this manner, the fibers are utilized almost exclusively for resistance to bending, for example, when the knob 5 is turned and the pads 3 apply a force to the clamped object. Each of a plurality of the unidirectional carbon fibers lays along the entire length of the main body, from the tip of the top of the c-shape of the main body 1 to the tip of the bottom of the c-shape of the main body 1. By manufacturing the carbon fiber c-clamp with unidirectional carbon fibers, an extremely high stiffness and low weight can be achieved. In addition, the clamp can be fabricated with arms that contain additional carbon fiber material near the base 7 of the c-shape. In this embodiment, additional fibers are preferably added within the composite layup only within this expanded region 6. These additional fibers are shorter than the fibers that lie along the entire length of the main body, and preferably form the innermost layers of the main body 1 when the main body 1 is being fabricated. By using different length fibers, a tapered thickness is formed. The stiffness of the clamp is altered by adjusting how much fiber is at the base 7 and how the thickness is tapered to the thinnest cross-section. As shown in the figures, this expansion, or changing thickness, of the carbon fibers can be made to increase the height 10 of the cross section (FIG. 1a), or the width 11 of the cross section (FIG. 1b).

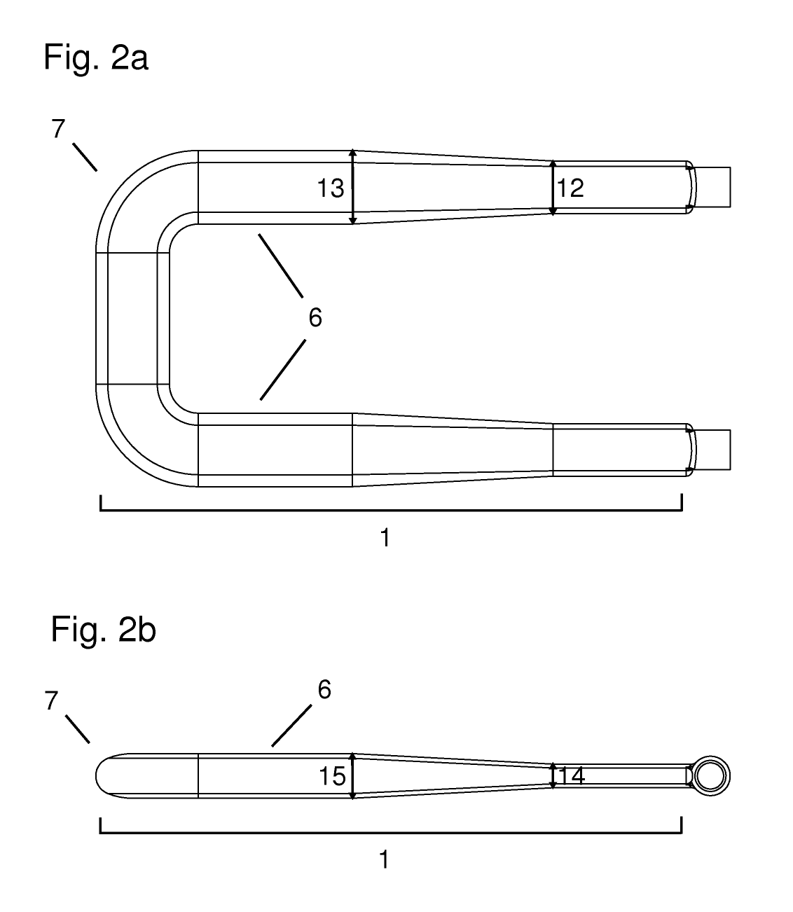

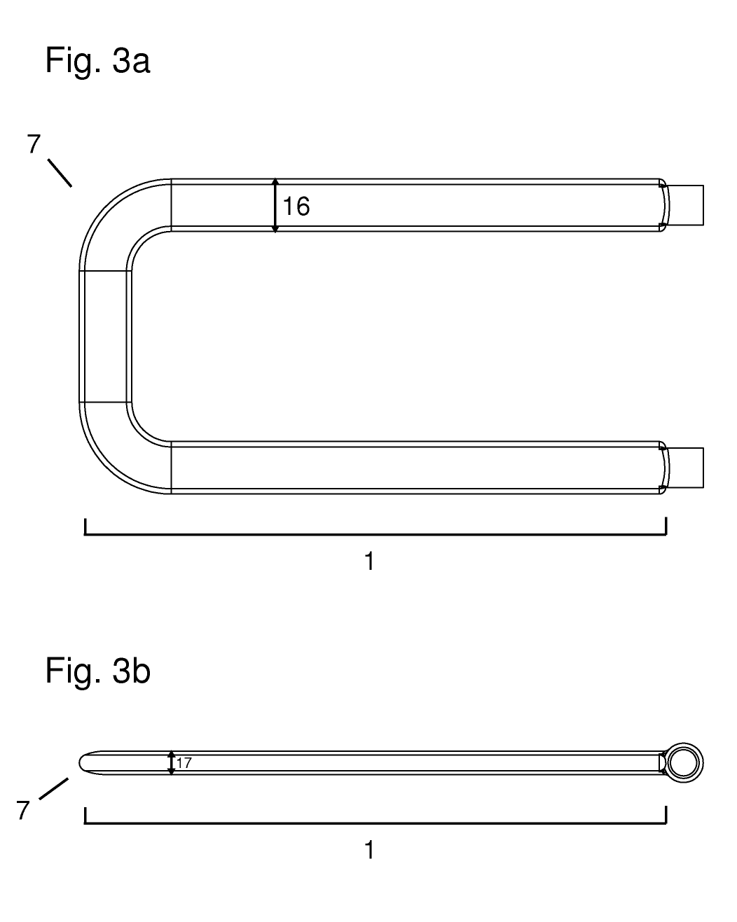

An example of a higher stiffness clamp, with a large thickness change from one end of the clamp to the other, is shown in FIGS. 2a and 2b. As shown in FIGS. 2a and 2b, there is a varying/changing thickness along a cross-section of the body of the clamp in these embodiments. The thickness is preferably tapered from the base 7 toward the clamping portion. In FIG. 2a, the height of the cross-section increases from 12 to 13 due to additional carbon fiber material near the base 7 of the c-shape. Similarly, as shown in FIG. 2b, the width of the cross-section increases from 14 to 15 due to additional carbon fiber material near the base 7 of the c-shape. In other embodiments, the placement of additional carbon fiber material may increase the height of the cross-section, while the width of the cross-section remains the same along the body. In still other embodiments, the placement of additional carbon fiber material may increase the width of the cross-section, while the height of the cross-section remains the same along the body. Alternatively, if a lower stiffness clamp is desired, the arms of the clamp can be fabricated with a constant cross-section along the length 16 and the width 17, as shown in FIGS. 3a and 3b.

In one preferred embodiment, the body 1 of the c-clamp is fabricated using a mold. The mold includes two halves with a c-shape that corresponds to the c-shape of the clamp, as shown in the figures. The fibers are laid up on one half of the mold. The other half of the mold is added and then the mold is clamped to hold the shape. For example, multiple unidirectional carbon fibers running the entire length of the mold are laid to form the outer most layers of the first half of the mold. Additional unidirectional fibers, which are shorter than the unidirectional carbon fibers placed as the outermost layers of the first half of the mold, are laid up around the base 7 to form the innermost layers of the first half of the mold. The shorter unidirectional carbon fibers create a thickness change from the base 7 to the ends of the main body 1. The length of the shorter unidirectional fibers may vary to form a gradual taper. As another example, all of the unidirectional carbon fibers placed in the first half of the mold run the entire length of the c-shape, creating a constant cross-section.

Instead of solely using unidirectional carbon fiber, in other embodiments, non-unidirectional carbon fiber, for example braid or woven cloth, can be included in the composite layup to give the clamp torsional rigidity. Non-unidirectional layers of carbon fiber are preferably added to the outermost layer of the main body 1. In one preferred embodiment, the non-unidirectional layer is a 45-degree bias braid material.

Torsional rigidity can also be increased by embedding metal or another highly stiff material within the middle of the carbon fiber layers. For example, steel, aluminum, titanium, or another metal add significant torsional rigidity to the clamp when placed in the middle of the carbon fiber clamp, with the carbon fibers completely surrounding the metal. This construction also improves the impact resistance of the clamp.

In order to create a carbon fiber c-clamp that does not readily conduct electricity, one or more layers of a material including, but not limited to, fiberglass, aramid fiber mesh, another non-conducting material, or a combination of these materials can be added to the outside or outermost layers of the clamp.

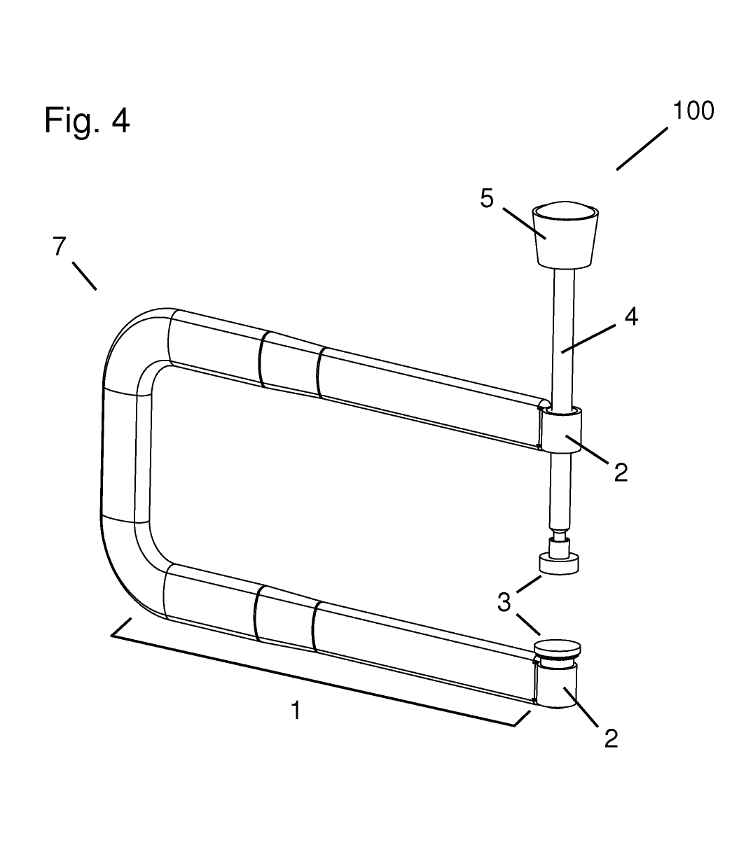

FIG. 4 shows an angled view of a carbon fiber c-clamp. The clamp preferably has a rounded, non-rectangular shape, which provides a smooth surface without sharp edges, reducing the potential for damage to a musical instrument. In addition, the surface finish is preferably smooth for the same reason. A coating can also be added to the outside of the clamp to further reduce surface roughness.

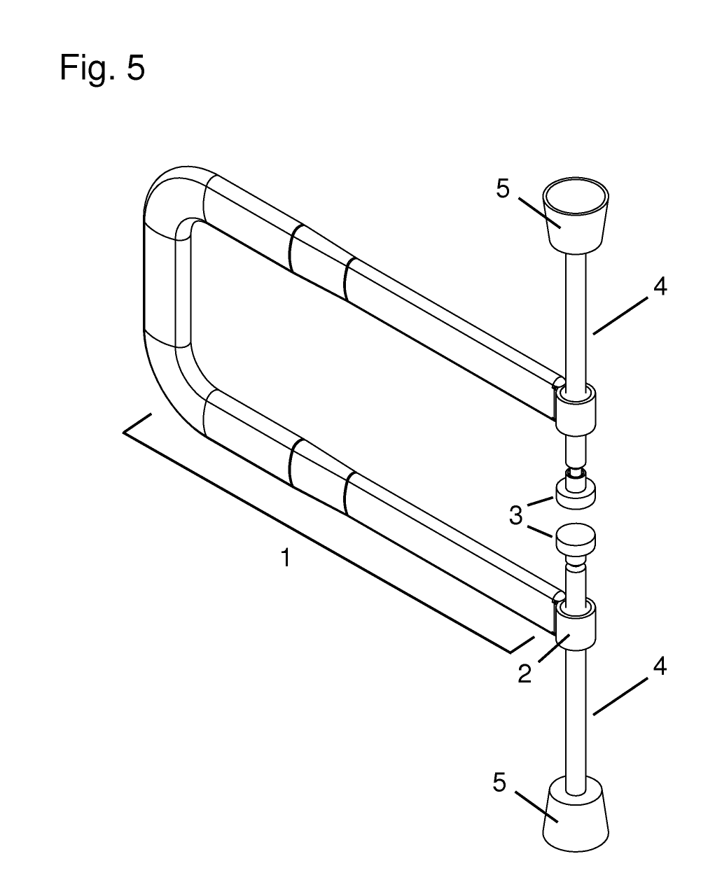

An alternative embodiment of the c-clamp 100 is shown in FIG. 5 with two threaded rods 4, instead of the single threaded rod version shown in FIG. 1a.

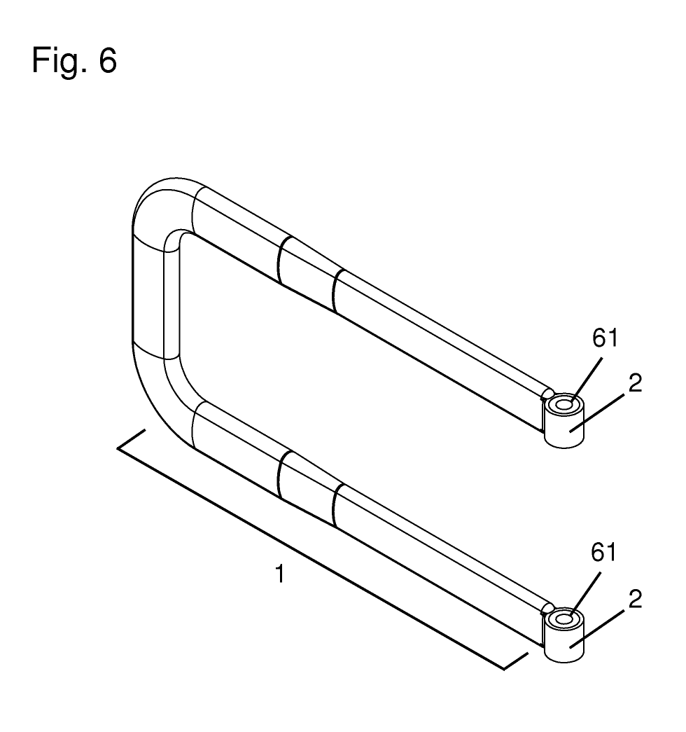

In preferred embodiments, threaded inserts 61, preferably made from metal, are captured by surrounding them with carbon fiber sleeves 2, as shown in FIG. 6. The carbon fiber sleeves 2 are preferably made by continuing the unidirectional carbon fibers from the main body 1 and wrapping them around the threaded inserts 61. In these embodiments, during fabrication, the sleeves 2 and the threaded inserts 61 become an integrated part of the main body of the clamp. This increases the strength and durability of the c-clamp. Alternatively, the carbon fiber sleeves 2 can be added to the main body after the main body 1 is fabricated by using an adhesive. Threaded inserts 61 may be used in any of the embodiments of the c-clamp discussed herein.

While specific designs for the c-clamp are shown in the figures, any known c-clamp design could be modified to include carbon fibers in the main body and/or the other components of the C-clamp (including the sleeves), to produce unique, lightweight, yet highly stiff c-clamps.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A c-clamp comprising a plurality of carbon fibers that form a c-shape main body, wherein the carbon fibers lay along a long axis of the main body and extend along an entire length of the main body.

2. The c-clamp of claim 1, wherein the carbon fibers are selected from the group consisting of:
a) unidirectional carbon fibers;
b) braided carbon fibers;
c) woven carbon fibers; and
d) any combination of a) through c).

3. The c-clamp of claim 1, wherein all of the carbon fibers extend along an entire length of the main body.

4. The c-clamp of claim 1, wherein at least one of the carbon fibers does not extend along an entire length of the main body.

5. The c-clamp of claim 4, wherein a cross-sectional dimension of the main body is not constant.

6. The c-clamp of claim 1, wherein the c-shape main body further comprises at least one layer selected from the group consisting of:
a) fiberglass;
b) aramid fibers;
c) a non-conducting material; and
d) any combination of a) through c).

7. The c-clamp of claim 1, wherein the c-shape main body further comprises a protective coating applied to an outer surface of the main body.

8. The c-clamp of claim 1, wherein the main body comprises a first arm and a second arm extending from a base to form the c-shape and wherein the c-clamp further comprises:
a) a first sleeve at an end of the first arm having an opening and a second sleeve at the end of the second arm, wherein the first sleeve and the second sleeve comprise carbon fiber;
b) a first threaded rod extending towards the second sleeve through the opening in the first sleeve;
c) a first pad at an end of the threaded rod facing the second sleeve; and
d) a second pad located on a side of the second sleeve facing the threaded rod.

9. The c-clamp of claim 8, further comprising a turning mechanism at an end of the first threaded rod opposite the first pad.

10. The c-clamp of claim 8, further comprising a second threaded rod extending towards the first sleeve through an opening in the second sleeve.

11. The c-clamp of claim 8, further comprising a threaded insert in at least one of the first sleeve or the second sleeve.

12. The c-clamp of claim 1, wherein the main body further comprises a material core that is not made of carbon fiber.

13. The c-clamp of claim 12, wherein the material core is selected from the group consisting of: steel; aluminum; and titanium.

14. A method for manufacturing a carbon fiber c-clamp comprising the steps of:
a) laying a plurality of carbon fibers along a long axis of a first half of a mold with a first half and a second half, wherein each half of the mold comprises a c-shaped channel that corresponds to a c-shape geometry of the clamp such that the carbon fibers extend along an entire length of the c-shaped channel;
b) placing the second half of the mold on top of the first half of the mold and clamping the first half and the second half together to hold a shape of the mold; and
c) removing the carbon fiber c-clamp from the mold.

15. The method of claim 14, wherein all of the carbon fibers extend substantially along an entire length of the c-shaped channel.

16. The method of claim 14, further comprising, between steps a) and b), the steps of:
d) embedding at least one insert within the carbon fibers; and
e) wrapping the carbon fibers around the insert in order to secure the insert in the mold.

17. The method of claim 14, wherein step a) comprises the substep of nonuniformly adding carbon fibers to the mold, wherein at least one of the carbon fibers is added along only a portion of the c-shape channel such that the c-shape has a variable cross-section.

18. The method of claim 14, further comprising, before step a), the step of fabricating the mold.

19. The method of claim 14, wherein the carbon fibers are selected from the group consisting of:
a) unidirectional carbon fibers;
b) braided carbon fibers;
c) woven carbon fibers; and
d) any combination of a) through c).

20. The method of claim 14, further comprising the step of laying at least one layer of fiberglass or aramid layers into the first half of the mold.

21. The method of claim 14, further comprising the step of laying at least one layer of a non-conducting material into the first half of the mold.

22. The method of claim 14, further comprising the step of laying a material core that is not made of carbon fiber into the first half of the mold.

23. The method of claim 22, wherein the material core is selected from the group consisting of: steel; aluminum; and titanium.

24. A c-clamp comprising a plurality of carbon fibers that form a c-shape main body, wherein the carbon fibers lay along a long axis of the main body and wherein the c-shape main body has a variable cross-section.

25. The c-clamp of claim 24, wherein the cross-section is variable along a dimension selected from the group consisting of:
a) a cross-sectional height of the main body;
b) a cross-sectional width of the main body; and
c) a combination of the cross-sectional height of the main body and the cross-sectional width of the main body.
